(19) United States
(12) Patent Application Publication
(10) Pub. No.: US 2024/0111846 A1
(43) Pub. Date: Apr. 4, 2024

(54) WATERMARK SERVER

(71) Applicant: MICRO FOCUS LLC, SANTA CLARA, CA (US)

(72) Inventors: DOUGLAS MAX GROVER, RIGBY, ID (US); MICHAEL F. ANGELO, HOUSTON, TX (US)

(73) Assignee: MICRO FOCUS LLC, SANTA CLARA, CA (US)

(21) Appl. No.: 17/956,664

(22) Filed: Sep. 29, 2022

(51) Int. Cl. G06F 21/16; G06F 21/31; H04L 9/40

(52) U.S. Cl. CPC G06F 21/16; G06F 21/31; H04L 63/0245; H04L 63/0281; G06F 2221/0737

(57) ABSTRACT

An indication of a user being authenticated is received. For example, the user authenticates with a valid username/password. In response to receiving the indication of the user being authenticated, a watermark is associated with the user. The watermark is sent to a communication device of the user. For example, the watermark is sent to the user's personal computer. The communication device of the user embeds the watermark into a communication. For example, the watermark may be embedded into a communication session with a web server. The watermark is sent to a routing device on a network (e.g., a router and/or firewall). The routing device uses the watermark embedded in the communication to determine how to route the communication on the network.

### FIELD

The disclosure relates generally to network security and particularly to securing a network using watermarks.

### BACKGROUND

Network security is an ever-evolving process where hackers are continually developing new ways to compromise a network. Even with sophisticated network security, breaches of security are continually in the news. Typically to secure a network, multiple solutions are required to prevent a breach of a secure network.

### SUMMARY

These and other needs are addressed by the various embodiments and configurations of the present disclosure. The present disclosure can provide a number of advantages depending on the particular configuration. These and other advantages will be apparent from the disclosure contained herein.

An indication of a user being authenticated is received. For example, the user authenticates with a valid username/password. In response to receiving the indication of the user being authenticated, a watermark is associated with the user. The watermark is sent to a communication device of the user. For example, the watermark is sent to the user's personal computer. The communication device of the user embeds the watermark into a communication. For example, the watermark may be embedded into a communication session with a web server. The watermark is sent to a routing device on a network (e.g., a router and/or firewall). The routing device uses the watermark embedded in the communication to determine how to route the communication on the network.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein and in the claims, the term “routing device” may include any device that can route packets. For example, a routing device may be a router, a proxy server, a gateway, a firewall, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for securing a private network using a watermark server.

FIG. 2 is a block diagram of a second illustrative system for securing multiple networks using a watermark server.

FIG. 3 is a flow diagram of a process for securing one or more networks using a watermark server.

FIG. 4 is a flow diagram of a process for securing one or more networks using a watermark server/authentication server.

FIG. 5 is a flow diagram of a process for removing watermarks from routing tables based on a user no longer being authenticated.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

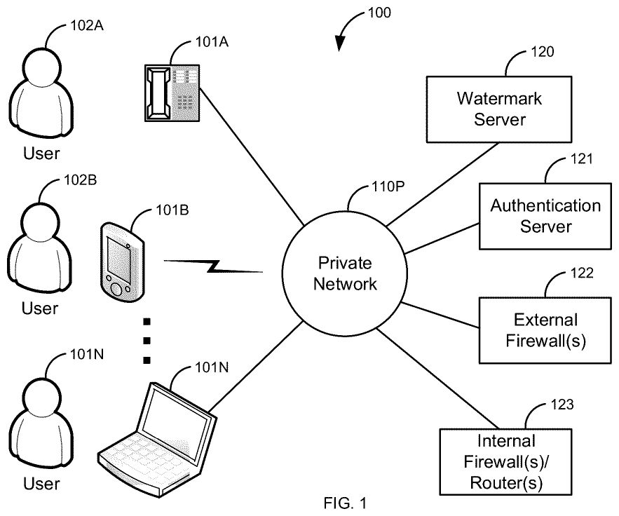

FIG. 1 is a block diagram of a first illustrative system 100 for securing a private network 110P using a watermark server 120. The first illustrative system 100 comprises communication devices 101A-101N, the private network 110P, the watermark server 120, an authentication server 121, external firewall(s) 122, and internal firewall(s)/router(s) 123. In addition, users 102A-102N are shown for convenience.

The communication devices 101A-101N can be or may include any device associated with a user that can communicate on the network 110, such as a Personal Computer (PC), a telephone, a video system, a cellular telephone, a Personal Digital Assistant (PDA), a tablet device, a notebook device, a smartphone, an embedded device, a server, and/or the like. As shown in FIG. 1, any number of communication devices 101A-101N may be connected to the network private 110P.

The private network 110P can be or may include any collection of communication equipment that can send and receive electronic communications, such as a Wide Area Network (WAN), a Local Area Network (LAN), a corporate network, a business network, a service provider network. a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications in a private setting.

The watermark server 120 can be or may include any hardware coupled with software that can manage the use of watermarks on the private network 110P. The watermark server 120 can generate and associate watermarks according to rules.

The authentication server 121 can be or may include any hardware coupled with software that can be used to authenticate the user 102A-102N. The authentication server 121 can authenticate the users 102A-102N using multi-factor authentication using one or more authentication levels. The authentication server 121 may use any known authentication factors, such as, SMS codes, email codes, chat codes, usernames/passwords, biometrics, questions, and/or the like. Although shown as separate, in one embodiment, the watermark server 120 and the authentication server 121 may be in a single device.

The external firewall(s) 122 can be any firewall that provides protection from an external network (e.g., the Internet), such as, a network address translator, a packet filtering firewall, a circuit level gateway, an application-level gateway, a stateful inspection firewall, a next generation firewall, and/or the like. The external firewall(s) 122 provide protection using various known techniques, such as, blocking ports, filtering packets, and/or the like.

The internal firewall(s)/router(s) 123 can be or may include any firewall/router that can route packets within the private network. The internal firewall(s)/router(s) 123 may be at different places within the private network, such as at a branch location, at a data center, and/or the like.

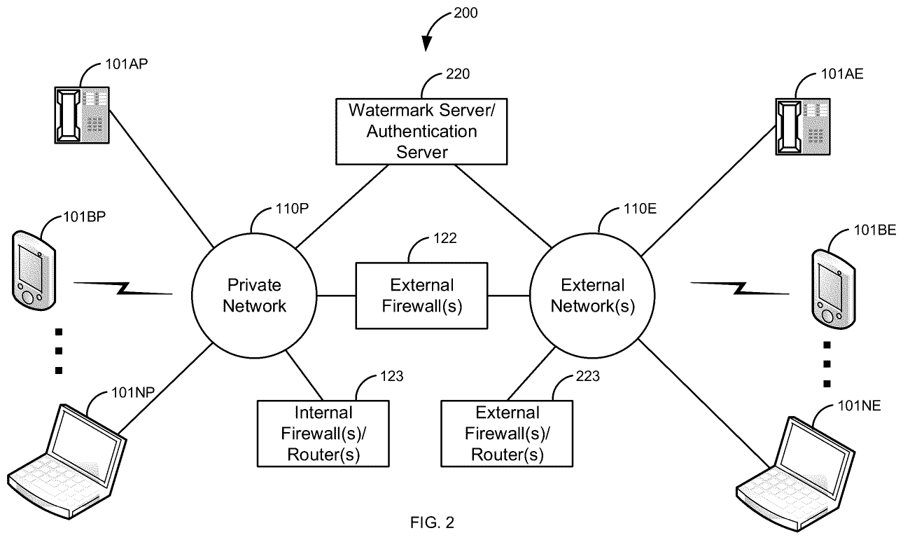

FIG. 2 is a block diagram of a second illustrative system 200 for securing multiple networks 110P/110E using a watermark server/authentication server 220. The second illustrative system 200 comprises communication device 101AP-101NP, communication devices 101AE-101NE, private network 110P, external network(s) 110E, external firewall(s) 122, internal firewall(s)/router(s) 123, watermark server/authentication server 220, and external firewall(s)/router(s) 223.

The communication devices 101AP-101NP/101AE-101NE may any type of communication device 101 that can communicate on the networks 110P/110E. The communication devices 101AP-101NP/101AE-101NE are similar to the communication devices 101A-101N. The external network(s) 110E may be any type of network 110 that is external to the private network 110P, such as, the Internet, a Wide Area Network (WAN), a Local Area Network (LAN), a packet switched network, a circuit switched network, a cellular network, a combination of these, and the like. The network 110E can use a variety of electronic protocols, such as Ethernet, Internet Protocol (IP), Hyper Text Transfer Protocol (HTTP), Web Real-Time Protocol (Web RTC), and/or the like. Thus, the network 110E is an electronic communication network configured to carry messages via packets and/or circuit switched communications.

The watermark server/authentication server 220 provides authentication/watermark services for the private network 110P and for the external network(s) 110E. The watermark server/authentication server 220 works similar to the watermark server 120/authentication server 121 and provides authentication/watermark services for multiple networks 110 for multiple entities (e.g., corporations).

The external firewall(s)/router(s) 223 are firewall(s)/router(s) that are part of the external network 110E. The external firewall(s)/router(s) 223 are used to route communications on the external network(s) 110E.

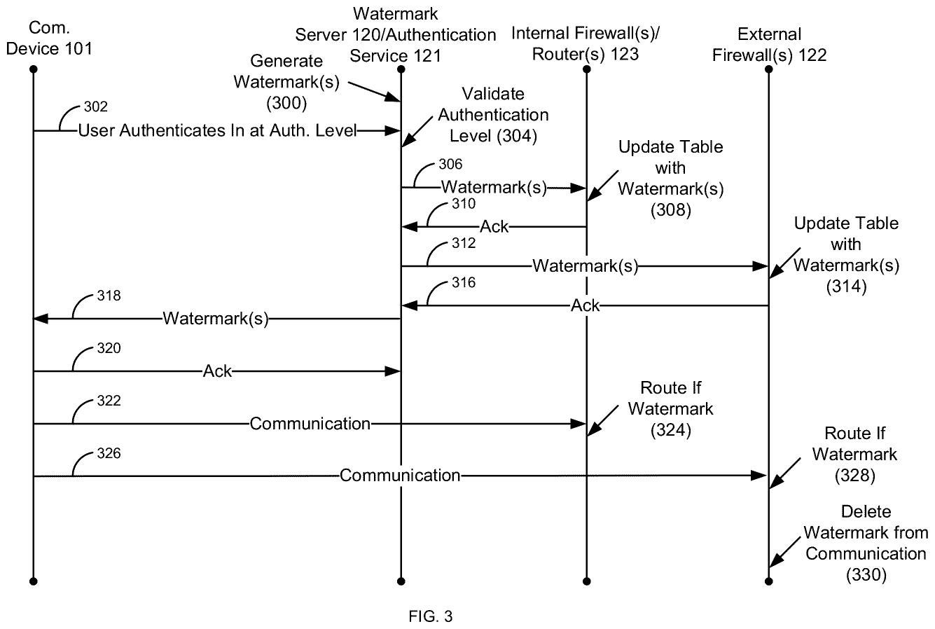

FIG. 3 is a flow diagram of a process for securing one or more networks 110 using a watermark server 120. Illustratively, the communication devices 101A-101N/101AP-101NP/101AE-101NE, the watermark server 120, the authentication server 121, the external firewall(s) 122, the internal firewall(s)/router(s) 123, the watermark server/authentication server 220, and the external firewall(s)/router(s) 223 are stored-program-controlled entities, such as a computer or microprocessor, which performs the method of FIGS. 3-5 and the processes described herein by executing program instructions stored in a computer readable storage medium, such as a memory (i.e., a computer memory, a hard disk, and/or the like). Although the methods described in FIGS. 3-5 are shown in a specific order, one of skill in the art would recognize that the steps in FIGS. 3-5 may be implemented in different orders and/or be implemented in a multi-threaded environment. Moreover, various steps may be omitted or added based on implementation.

The process of FIG. 3 is discussed in relation to FIG. 1. In FIG. 3, although shown as separate entities, the watermark server 120/authentication server 121 are discussed as a single entity and may reside as a single entity in some embodiments. Alternatively, the watermark server 120/authentication server 121 may be separate as shown in FIG. 1. The watermark server 120 generates watermarks for each authentication level of the user(s) 102 in step 300. The watermark may by various sizes/types based on implementation. For example, the watermark may be different sizes based on the protocol type, where the watermark is being placed, and/or the like.

The user 102 authenticates at an authentication level, in step 302, by providing the necessary authentication credentials. For example, the user 102 may authenticate by providing a valid username/password and a valid fingerprint scan (authentication level two) in step 302. The authentication server 121 validates the authentication credentials/level in step 304. An IP address (or other associated address) of the user's communication device 101 may be captured by watermark server 120/authentication server 121 (e.g., so the external firewall(s) 122/internal firewall(s)/router(s) 123 can determine if the watermark originates from the user's communication device 101). The watermark server 120/authentication server 121 sends the watermark(s) to the internal firewall(s)/router(s) 123 and/or to the external firewall(s)/router(s) 122 in steps 306/312 (based on rules defined by the watermarks). The watermark(s) sent in steps 306/312 may include other information, such as, a location of where the watermark will be (e.g., in a specific field in a specific protocol header).

The internal firewall(s)/router(s) 123 update their routing tables with the watermark(s)/watermark information in step 308. Likewise, the external firewall(s) 122 update their routing tables with the watermark(s)/watermark information in step 314. The internal firewall(s)/router(s) 123 acknowledge receipt of the watermark(s)/watermark information in step 310. Likewise, the external firewall(s) 122 acknowledge receipt of the watermark(s)/watermark information in step 316.

The watermark server 120/authentication server 121 sends the watermark(s)/watermark information to the communication device 101 in step 318. The communication device 101 acknowledges the receipt the watermarks/watermark information in step 320. The communication device 101 then embeds the watermark into a communication in step 322. The watermark may be embedded into the communication in various ways. For example, the watermark may be sent using the least significant bits of a voice/video stream (e.g., over multiple packets), using unused/undefined fields in a header, using user defined fields in a header, by inserting an extra field/header, by embedding the watermark into a payload, and/or the like.

The internal firewall(s)/router(s) 123 routes/does not route the communication based on the watermark(s)/watermark information in step 324. Likewise, the communication of step 326 gets routed/not routed by the external firewall(s) in step 328 based on the watermark information. Although not shown in FIG. 3, a communication may pass through both the internal firewall(s)/router(s) 122/external firewall(s) 122. The external firewall(s) 122 may delete the watermark in step 330 based on one or more rules.

The communication of steps 322/326 is routed by the internal firewall(s)/router(s) 123 according to information associated with the watermark that is stored in the routing tables. The information associated (i.e., routing factors) with the watermark may be defined in various ways based on implementation/network configuration. The watermark information is typically administered. For example, an administrator may use a watermark template (e.g., for a group of users) to define the watermark information. Table 1 provides an illustrative example of information associated with a watermark.

TABLE 1

| | | Authentication | | | |
|---|---|---|---|---|---|
| User | Watermark | Level | Port | Connection Type | Internal/External |
| User A | AAAAAA | Level 1 | All | Inbound/Outbound | Internal |
| User A | BBBBBB | Level 2 | All | Inbound/Outbound | Internal/External |
| User B | CCCCCC | Level 1 | 80 (HTTP) | Outbound | External |
| User C | DDDDDD | Level 1 | 80 (HTTP), | 80 - Out | 80 - External |
| | | | 22 (FTP), | 22 - In/Out | 22 - Internal |
| | | | 5060-5061 (SIP) | 5050-5061 In/Out | 5060-5061 -In/Ext |
| User C | EEEEEE | Level 2 | All | All | All |
| User D | FFFFFF | Level 1 | All (except 5060- | All (except 5060- | All (except 5060- |
| | | | 5061 (SIP) | 5061 (SIP) | 5061 (SIP) |
| | XXXXXX | Level 2 | TLS | 5050-5061 In/Out | 5060-5061 -In/Ext |
| | YYYYYY | | 5060-5061 (SIP) | | |

In Table 1, the watermark AAAAAA is associated with user 102A's authentication level one. When user 102A is authenticated at level one (e.g., with a username/password), communications associated with user 102A can use all ports, with a connection type of inbound/outbound, and only internal communications. In order to leave the private network 110P, the user 102A must authenticate at level two (e.g., with a username/password and voiceprint) to get the watermark BBBBBB.

The ability to communicate on the network may vary based on the attributes associated with the watermark. For example, the user 102B, who only has a single authentication level (level 1), is only allowed to use the HTTP port 80 (HTTP) for outbound external connections using the watermark CCCCCC.

For level one authentication, the user 102C can use ports 80 (HTTP), 22 (File Transfer Protocol), and 5060-5061 (Session Initiation Protocol (SIP)) using the watermark DDDDDD. For port 80, the user 102C can make outbound external HTTP connections. For port 22, the user 102C can use inbound/outbound internal connections. For ports 5060-5061 the user 102C can make inbound/outbound SIP communication sessions. For authentication level two, the user 102C can use all ports, make any inbound/outbound connections (both internal and external) using the watermark EEEEEE.

The watermark information may apply at a protocol level. For example, if a TCP/H.323/WebRTC/SIP (i.e., any connection-oriented protocol) session is established, the watermark may only need to be in the initial packet that initiates the communication session. For example, the internal firewall(s)/router(s) 123/external firewall(s) 122 may look for a specific types of connection packets (i.e., an initial setup message), such as, a TCP SYN message, a SIP INVITE message, a SCCP Dial message, and/or the like. If the initial packet does not contain the watermark, the packet is dropped, and the connection cannot be established. Alternatively, the internal firewall(s)/router(s) 123/external firewall(s) 122 may require every packet to have the watermark.

The user 102D, at level one authentication may use the watermark FFFFFF to have access to all ports/connections/internal/external communications with the exception of SIP voice/video calls. However, for the user 102D to make a SIP voice/video call, it requires two watermarks for different protocols (Transport Layer Security (TLS) and SIP). If the user 102D wants to make a SIP call, the user 102D must have authenticated at level two. The watermark XXXXXX is embedded into the TLS header/data and the watermark YYYYYY is embedded into the SIP header/data. For example, the watermark XXXXXX may be sent in a TLS header and the watermark YYYYYY may be sent in place of the least significant bits of voice/video data (e.g., using bit robbed signaling techniques). While Table 1 uses TLS/SIP, the watermarks may be used at any level/protocol (e.g., any layer (except layer 1) of the seven-layer OSI 7-layer model). In this example, the internal firewall(s)/router(s) 123/external firewall(s) 122 would have to be able to unencrypt the packets to access the watermarks.

The watermarks may come from two different watermark servers 120/authentication servers 121 where higher security is needed. For example, the user 102D may need to authenticate to first watermark server 120/authentication server 121 to get the TLS watermark XXXXXX/encryption key and then authenticate to a second watermark server 120/authentication server 121 to get the watermark YYYYYY.

The watermarks may be based on a single authentication factor, based on multiple authentication factors, based on a time period, (e.g., 24 hours), based on a communication session, based on a number of communication sessions, and/or the like.

Individual watermarks may be rotated based on various factors, such as, for each authentication, based on a number of authentications, based on a time period, based on an event, and/or the like. Rotating the watermarks improves the ability to prevent misuse of the watermarks. For example, a new watermark may be generated based on each valid user authentication. Once the user logs out, the watermark is invalidated, and a message is sent to the routers/firewalls. To prevent compromise of the watermarks, the watermarks may be encrypted when initially transmitted on the network 110P.

The watermarks may apply only to specific types of communications. For example, the external firewall(s) 122/internal firewall(s)/router(s) 123 may only look for the watermark in communications using specific ports (e.g., only ports that are not blocked by the external firewall 122). In this case, the watermark server 120/authentication service 121 would send a message to the firewall(s)/router(s) to ignore any packets that are not in the defined list. In addition, the watermark(s)/watermark information may only be sent to a specific firewall(s)/router(s) 122/123. For example, the watermark information may only be sent to the external firewall 122 and/or routers 123 on a specific sub-network. In addition, the watermark information may include instructions to remove the watermark(s) based on one or more conditions. For example, the external firewall 122 may remove the watermark for communications that are routed outside of the private network so that the watermark is not disclosed publicly.

In one embodiment, a proxy (e.g., a proxy server or gateway) may be used to embed the watermark instead of the user's communication device 101. For example, the watermark may be set to a proxy device that provides the watermark instead of the user's communication device 101. When the user tries to make a connection, the proxy device receives the request and then embeds the watermark(s) into the communication. The proxy device could also be used for other types of devices. For example, a printer may use a proxy for embedding the watermarks for communications on the private network 110P. In this example, the proxy would be considered a communication device 101 of the user 102.

In one embodiment, the user 102 may define how the proxy manages multiple devices associated with the user 102. For example, the user 102 (or an administrator) may define a group of associated communication devices 101 associated with the user 102. The list of communication device is sent as part of the watermark information.

In addition, a list of excluded communication devices 101 may also be used for legitimate communication devices 101 that are not capable of using a watermark. For example, the IP addresses of the printer may be excluded.

Another advantage of this solution is that the watermark is associated with a user 102. If a malicious connection is made with an invalid watermark, it potentially can be tracked back to a specific user 102/watermark/communication device 101. To track watermarks/users 102, the watermark server 120/authentication server 121 stores watermarks that are no longer valid. For example, if a communication is attempted using a previously used watermark, this can be tracked and flagged as a potential malicious use of the watermark. In addition, machine learning can be applied to the use of watermarks to identify potential anomalies associated with the use of a watermark. If a malicious activity/communication is made without a valid watermark or an anomaly is detected in the use of watermarks, an action can be taken, such as, notifying a user, administrator, or other monitoring entity. The usage of the watermarks/routing information may be captured and stored for retrieval by a network management system/machine learning algorithm.

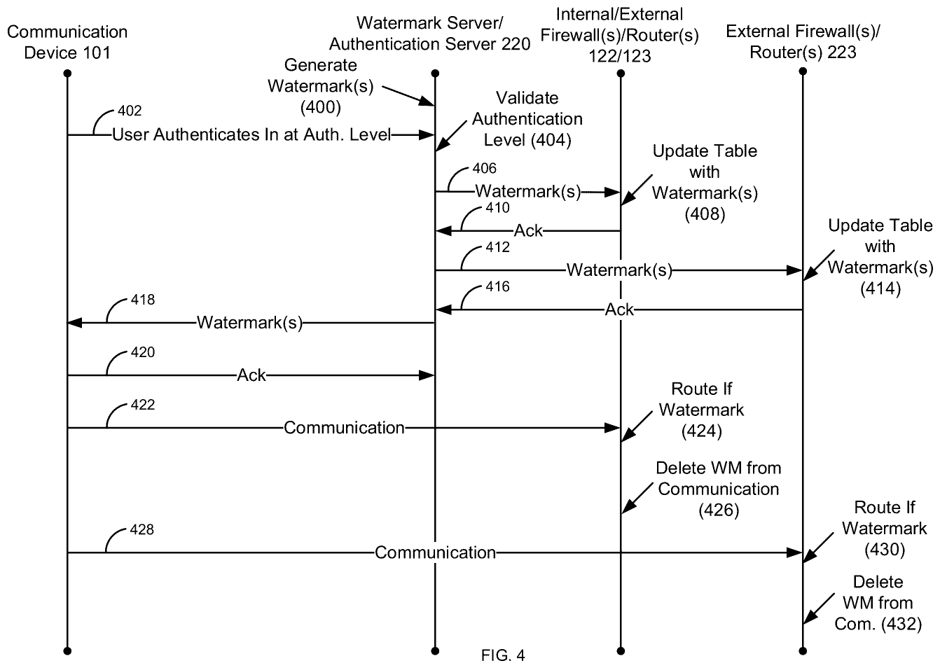

FIG. 4 is a flow diagram of a process for securing one or more networks 110P/110E using a watermark server/authentication server 220. The process described in FIG. 3 can be extended to the multi-network system of FIG. 2. In FIG. 2, the watermark server 120/authentication server 121 are shown as a single entity 220. In some embodiments, the watermark server/authentication server 220 may be separate. The watermark server/authentication server 220 generates watermarks for each authentication level of the user(s) 102 in step 400.

The user 102 authenticates at an authentication level, in step 402, by providing the necessary authentication credentials. For example, the user 102 may authenticate by providing a valid username/password and a valid email code (authentication level two) in step 402. The watermark server/authentication server 220 validates the authentication credentials/level in step 404. An IP address (or other associated address) of the user's communication device 101 may be captured by watermark server/authentication server 220. The watermark server/authentication server 220 sends the watermark(s) to the internal firewall(s)/router(s) 123/external firewall(s)/router(s) 122 in step 406. The internal firewall(s)/router(s) 123/external firewall(s)/router(s) 122 update their routing tables based on the watermark/watermark information in step 408. The internal firewall(s)/router(s) 123/external firewall(s)/router(s) 122 acknowledge receipt of the watermark(s)/watermark information in step 410. The watermark server/authentication server 220 sends the watermark(s) to the external firewall(s)/router(s) 223 in step 412. The external firewall(s)/router(s) 223 update their routing tables based on the watermark/watermark information in step 414. The external firewall(s)/router(s) 223 acknowledge receipt of the watermark(s)/watermark information in step 416.

The watermark server/authentication server 220 sends the watermark(s)/watermark information to the communication device 101 in step 418. The communication device 101 acknowledges the receipt the watermarks/watermark information in step 420. The communication device 101 then embeds the watermark into a communication in step 422. The external firewall(s) 122/internal firewall(s)/router(s) 123 routes/does not route the communication based on the watermark(s)/watermark information in step 424. The external firewall(s) 122 may delete the watermark from the communication in step 426.

Likewise, the communication of step 428 gets routed/not routed by the external firewall(s)/router(s) 223, in step 430 based on the watermark/watermark information. The external firewall(s)/router(s) 223 may delete the watermark in step 432 based on one or more rules.

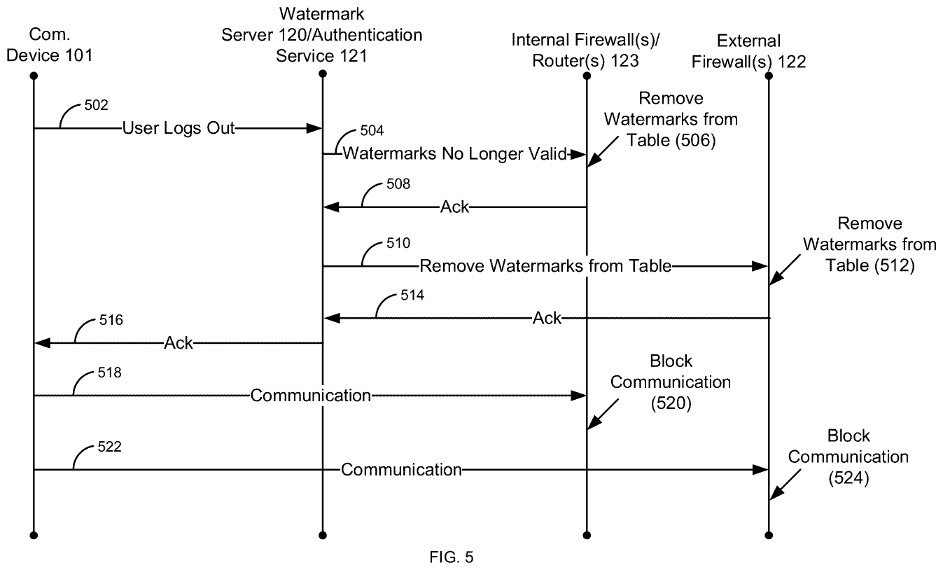

FIG. 5 is a flow diagram of a process for removing watermarks from routing tables based on a user 102 no longer being authenticated. Although shown in relation to FIG. 3, the process of FIG. 5 may apply also to FIG. 4. The user 102 logs out in step 502. Although not shown, other events could trigger a logout type event, such as, an inactivity event, a forced logout event, and/or the like.

When the watermark server 120/authentication service 121 receives the user logout of step 502, the watermark server 120/authentication service 121 sends a message to the internal firewall(s)/router(s) 123 that the user's watermark(s) are no longer valid. The internal firewall(s)/router(s) 123 removed the watermarks for the routing tables in step 506. The internal firewall(s)/router(s) 123 acknowledge receipt of the message of step 504 in step 508. Likewise, watermark server 120/authentication service 121 sends a message to the external firewall(s) 122 that the user's watermark(s) are no longer valid. The external firewall(s) 122 removed the watermarks from the routing tables in step 512. The external firewall(s) 122 acknowledge receipt of the message of step 510 in step 514. The watermark server 120/authentication service 121 acknowledges the logout in step 516.

When a communication is attempted using the watermark(s) in step 518, the internal firewall(s)/router(s) 123 blocks the communication in step 520. Likewise, when a communication is attempted using the watermark(s) in step 522, the external firewall(s) 122 blocks the communication in step 524.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive an indication of a user being authenticated;
in response to receiving the indication of the user being authenticated, associating a first watermark with the user;
send the first watermark to a communication device of the user, wherein the communication device of the user embeds the watermark into a communication; and
send the first watermark to a first routing device on a network, wherein the first routing device uses the first watermark embedded in the communication to determine how to route the communication on the network.

2. The system of claim 1, wherein authenticating the user comprises authenticating the user at a first authentication level of a plurality of authentication levels associated with the user and wherein a second authentication level of the plurality of authentication levels has a second watermark associated with the user.

3. The system of claim 1, wherein the first watermark has at least one associated routing factor and wherein the at least one associated routing factor comprises at least one of: a port, an Internet Protocol (IP) address, a connection type, an internal routing, an external routing, a protocol type, and a time period.

4. The system of claim 1, wherein the communication is a communication session, wherein the first watermark has a routing factor associated with a setup message of the communication session and wherein the first routing device allows the communication session if the setup message contains the first watermark.

5. The system of claim 1, wherein the first watermark applies to a first type of communication and wherein the first routing device restricts specific communications associated with the first type of communication and routes all other types of communications.

6. The system of claim 1, wherein the network comprises a private network and an external network, wherein the first watermark comprises a plurality of watermarks, and wherein the plurality of watermarks comprises an internal watermark for the private network and an external watermark for the external network.

7. The system of claim 6, wherein the first watermark is removed by a firewall when the communication is sent to the external network and wherein a second routing device on the external network uses the second watermark for routing the communication on the external network.

8. The system of claim 1, wherein the communication device of the user is a proxy server.

9. The system of claim 1, wherein the first watermark is at least one of: embedded into a least significant bit of a voice stream, embedded into a least significant bit of a video stream, embedded in in an unused field in a header, embedded in in an undefined field in a header, embedded in in a user defined field in a header, inserted into an extra field/header, and embedded into a payload.

10. The system of claim 1, wherein the first watermark comprises a plurality of watermarks and wherein the plurality of watermarks are generated by a plurality of watermark servers that each require a separate authentication by the user or a separate authentication by a plurality of users.

11. The system of claim 1, wherein the microprocessor readable and executable instructions further cause the microprocessor to:
receive an indication that the user is no longer authenticated; and
in response to receiving the indication that the user is no longer authenticated, send a message to the first routing device that the first watermark is no longer valid.

12. A method comprising:
receiving, by a microprocessor, an indication of a user being authenticated;
in response to receiving the indication of the user being authenticated, associating, by the microprocessor, a first watermark with the user;
sending, by the microprocessor, the first watermark to a communication device of the user, wherein the communication device of the user embeds the watermark into a communication; and
sending, by the microprocessor, the first watermark to a first routing device on a network, wherein the first routing device uses the first watermark embedded in the communication to determine how to route the communication on the network.

13. The method of claim 12, wherein authenticating the user comprises authenticating the user at a first authentication level of a plurality of authentication levels associated with the user and wherein a second authentication level of the plurality of authentication levels has a second watermark associated with the user.

14. The method of claim 12, wherein the first watermark has at least one associated routing factor and wherein the at least one associated routing factor comprises at least one of: a port, an Internet Protocol (IP) address, a connection type, an internal routing, an external routing, a protocol type, and a time period.

15. The method of claim 12, wherein the communication is a communication session, wherein the first watermark has a routing factor associated with a setup message of the communication session and wherein the first routing device allows the communication session if the setup message contains the first watermark.

16. The method of claim 12, wherein the network comprises a private network and an external network, wherein the first watermark comprises a plurality of watermarks, and wherein the plurality of watermarks comprises an internal watermark for the private network and an external watermark for the external network.

17. The method of claim 16, wherein the first watermark is removed by a firewall when the communication is sent to the external network and wherein a second routing device on the external network uses the second watermark for routing the communication on the external network.

18. The method of claim 12, wherein the first watermark comprises a plurality of watermarks and wherein the plurality of watermarks are generated by a plurality of watermark servers that each require a separate authentication by the user or a separate authentication by a plurality of users.

19. The method of claim 12, further comprising:
receiving an indication that the user is no longer authenticated; and
in response to receiving the indication that the user is no longer authenticated, sending a message to the first routing device that the first watermark is no longer valid.

20. A non-transient computer readable medium having stored thereon instructions that cause a microprocessor to execute a method, the method comprising instructions to:
receive an indication of a user being authenticated;
in response to receiving the indication of the user being authenticated, associate a watermark with the user;
send the watermark to a communication device of the user, wherein the communication device of the user embeds the watermark into a communication; and
send the watermark to a routing device on a network, wherein the routing device uses the watermark embedded in the communication to determine how to route the communication on the network.
